(19) United States
(12) Patent Application Publication
(10) Pub. No.: US 2025/0334469 A1
(43) Pub. Date: Oct. 30, 2025

(54) INLET FILTERS AND PRESSURE SENSORS HAVING INLET FILTERS

(71) Applicant: Illinois Tool Works Inc., Glenview, IL (US)

(72) Inventors: Chris Fontana, Allentown, PA (US); Hai Mei, Pelham, NH (US)

(21) Appl. No.: 19/174,613

(22) Filed: Apr. 9, 2025

Related U.S. Application Data
(60) Provisional application No. 63/640,832, filed on Apr. 30, 2024.

(51) Int. Cl. G01L 19/06; G01L 19/04

(52) U.S. Cl. CPC G01L 19/0636; G01L 19/04

(57) ABSTRACT

Disclosed example pressure sensors include: a pressure sensor comprising a fluid input and a sensor housing configured to contain a reference pressure, and configured to output a signal representative of a pressure sensed at the fluid input; and an inlet filter configured to reduce byproducts entering the pressure sensor with a process gas, the inlet filter comprising: a thermally conductive filter in fluid communication with the fluid input of the pressure sensor, and comprising a plurality of surfaces at least partially impeding a flow path of the process gas toward the fluid input of the pressure sensor; and a cooler thermally coupled to the thermally conductive filter and configured to cool the thermally conductive filter.

### RELATED APPLICATIONS

The present application claims the benefit of U.S. Provisional Patent Application Ser. No. 63/640,832, filed Apr. 30, 2024, entitled “INLET FILTERS AND PRESSURE SENSORS HAVING INLET FILTERS.” The entirety of U.S. Provisional Patent Application Ser. No. 63/640,832 is expressly incorporated herein by reference.

### FIELD OF THE DISCLOSURE

This disclosure is directed generally to pressure sensors and, more particularly, to inlet filters and pressure sensors having inlet filters.

### BACKGROUND

Pressure sensors, or pressure sensors, measure the pressure of a fluid input to the sensor compared to a reference pressure. Pressure sensors may be constructed to compare the input pressure to a fixed reference pressure or to a variable reference pressure.

### SUMMARY

Inlet filters and pressure sensors having inlet filters are disclosed, substantially as illustrated by and described in connection with at least one of the figures, as set forth more completely in the claims.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of an example process control system including a pressure sensor having a fixed reference pressure, in accordance with aspects of this disclosure.

FIG. 2 is a schematic diagram of an example pressure sensor and inlet filter which may be used to implement the pressure sensor and inlet filter of FIG. 1.

FIG. 3 is a perspective view of an example inlet filter that may be used to implement the inlet filters of FIGS. 1 and 2.

FIG. 4 is an end elevation view of the example inlet filter of FIG. 3.

FIG. 5 is an exploded view of the inlet filter of FIG. 3.

FIG. 6 is a cross-sectional view of another example thermally conductive filter that may implement the thermally conductive filter of FIG. 2.

FIG. 7 is a flowchart representative of an example method that may be performed to filter contaminants from an input to a pressure sensor, in accordance with aspects of this disclosure.

The figures are not necessarily to scale. Wherever appropriate, similar or identical reference numerals are used to refer to similar or identical components.

### DETAILED DESCRIPTION

For the purpose of promoting an understanding of the principles of the claimed technology and presenting its currently understood, best mode of operation, reference will be now made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would typically occur to one skilled in the art to which the claimed technology relates.

Vacuum manometers are used in semiconductor processing applications, such as to measure pressures associated with wafer processing chambers. During various processes, gaseous byproducts of the processing applications tend to form and condense onto surfaces, and particularly on colder surfaces. When these byproducts settle onto the vacuum manometer, particularly on the diaphragm of a Capacitance Diaphragm Gauge (CDG), the byproducts affect the stability or repeatability of the sensor output. Because conventional CDG diaphragms are very thin to provide high sensitivity in low vacuum measurements, CDG diaphragms are also susceptible to added thickness and/or surface tension from the deposition of byproducts. Conventional vacuum manometers must be replaced, which can incur undesirable costs and destabilize process parameters.

Conventional vacuum manometers have included features such as mechanical trapping, which may involve employing surface profiles, baffles, and/or tortuous gas flow paths to cause the byproducts to impinge on the trap surfaces prior to reaching the diaphragm. Conventional vacuum manometers have also involved performing chemical decomposition and/or reaction into solids to improve trapping. Some conventional CDG sensors are heated to reduce condensation of process byproducts.

Disclosed example pressure sensors and filters for pressure sensors provide improved operating life by reducing contaminants that reach the pressure sensor. Disclosed example pressure sensors and filters for pressure sensors perform cooling of contaminants in the flow path, thereby causing condensation of the contaminants onto a filter surface. In some examples, cooling is performed via thermoelectric or Peltier cooling, which is connected to the exterior surfaces of the process connection tube of the pressure sensor and thermally coupled to the filter device within the flow path. In some examples, thermal conduction between the cooler and the filter is further improved using thermally conductive materials, such as interfaces and/or thermal conducting fillers.

In some examples, a filter is provided within the flow path. Example filters include increased surface areas to aid in particle condensation when the cooling module reduces the temperature of the filter below the condensation temperature of the contaminants. Example filters can be easily replaced, thereby reducing or avoiding obstructions to gas flow caused by the accumulation of contaminant particles on the filter.

Disclosed example pressure sensors include: a pressure sensor having a fluid input and a sensor housing configured to contain a reference pressure, and configured to output a signal representative of a pressure sensed at the fluid input; and an inlet filter configured to reduce byproducts entering the pressure sensor with a process gas, the inlet filter including: a thermally conductive filter in fluid communication with the fluid input of the pressure sensor, and having a plurality of surfaces at least partially impeding a flow path of the process gas toward the fluid input of the pressure sensor; and a cooler thermally coupled to the thermally conductive filter and configured to cool the thermally conductive filter.

In some example pressure sensors, the thermally conductive filter includes a plurality of fins extending from an inner wall of the thermally conductive filter into the flow path. In some example pressure sensors, the thermally conductive filter is at least one of stainless steel or a nickel alloy. In some example pressure sensors, the cooler includes at least one of a thermoelectric cooler or a liquid cooler.

In some example pressure sensors, the inlet filter further includes a filter housing coupled to the fluid input and configured to hold the thermally conductive filter in the flow path. In some such examples, the filter housing is coupled to the fluid input via a connector. In some example pressure sensors, the filter housing is integrated into the fluid input.

Some example pressure sensors further include a retaining ring configured to be removably installed in the filter housing to retain the thermally conductive filter in a predetermined position. In some example pressure sensors, the thermally conductive filter is removable from the filter housing when the retaining ring is removed.

Some example pressure sensors further include at least one of an adapter or a thermally conductive filler, in which the at least one of the adapter or the thermally conductive filler is configured to transfer heat from the thermally conductive filter to the cooler.

Disclosed example inlet filters include: a thermally conductive filter configured to be installed in fluid communication with a fluid input of a pressure sensor, and having a plurality of surfaces configured to at least partially impede a flow path through the thermally conductive filter; and a cooler thermally coupled to the thermally conductive filter and configured to cool the thermally conductive filter.

In some example inlet filters, the thermally conductive filter includes a plurality of fins extending from an inner wall of the thermally conductive filter into the flow path. In some example inlet filters, the cooler includes at least one of a thermoelectric cooler or a liquid cooler.

Some example inlet filters further include a filter housing coupled to the fluid input and configured to hold the thermally conductive filter in the flow path. Some example inlet filters further include a retaining ring configured to be removably installed in the filter housing to retain the thermally conductive filter in a predetermined position. In some example inlet filters, the thermally conductive filter is removable from the filter housing when the retaining ring is removed. In some example inlet filters, the filter housing is configured to be coupled to the fluid input via a first connector. In some example inlet filters, the filter housing is configured to be coupled to a source of process gas via a second connector, the thermally conductive filter configured to be positioned between the first connector and the second connector.

In some example inlet filters, the filter housing is integrated into the fluid input. Some example inlet filters further include at least one of an adapter or a thermally conductive filler, in which the at least one of the adapter or the thermally conductive filler is configured to transfer heat from the thermally conductive filter to the cooler. In some example inlet filters, the thermally conductive filter is at least one of stainless steel or a nickel alloy.

Disclosed example methods to filter an input to a pressure sensor include: coupling an inlet filter to a fluid input of the pressure sensor, the inlet filter comprising a thermally conductive filter in fluid communication with the fluid input of the pressure sensor, and including a plurality of surfaces at least partially impeding a flow path toward the fluid input of the pressure sensor; actively cooling the filter to cause condensation of contaminants onto the filter; and at least one of cleaning the filter or replacing the filter to remove the contaminants from the flow path.

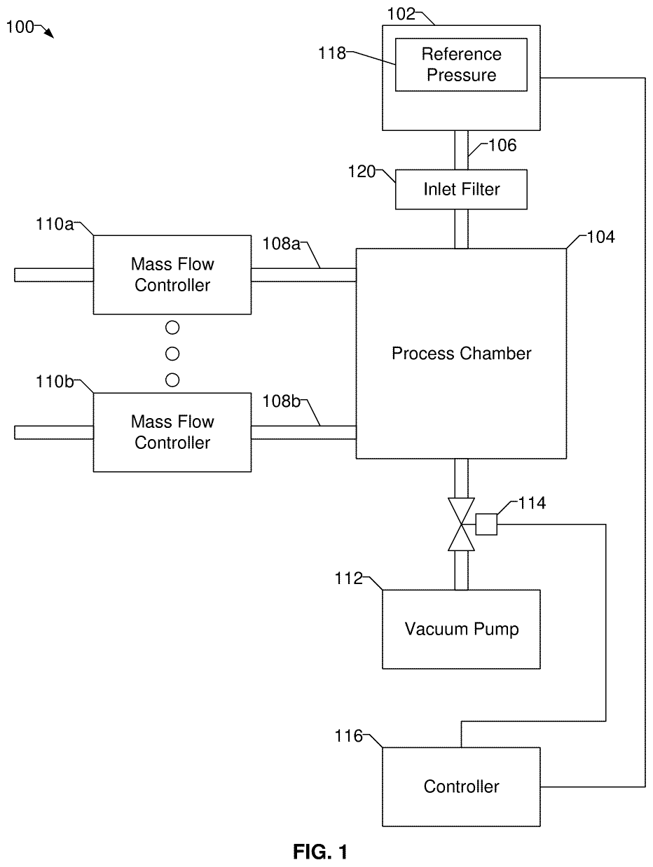

FIG. 1 is a block diagram of an example process control system 100 including a pressure sensor 102. The example process control system 100 of FIG. 1 includes a process chamber 104, to which the pressure sensor 102 is fluidly coupled via a fluid input line 106 to measure the pressure of the process chamber 104.

The example process chamber 104 may receive one or more inputs, such as process feed materials, via a corresponding number of feed lines 108a, 108b, which may be controlled via mass flow controllers 110a, 110b.

The example system 100 may include a vacuum pump 112, or other pressure control pump, and a valve 114 to control a flow rate between the vacuum pump 112 and the process chamber 104. The valve 114 may be controlled by a controller 116, computing device, and/or any other control technique, to maintain the pressure in the process chamber 104 within a desired range. The example pressure sensor 102 is communicatively coupled to the controller 116 to provide pressure feedback to the controller 116 (e.g., for use in a pressure control loop). For example, as the pressure in the process chamber 104 increases, the pressure sensor 102 measures the pressure and provides a signal representative of the pressure to the controller 116, which then controls the valve 114 to increase the flow rate from the process chamber 104 to the vacuum pump 112. The vacuum pump 112 may have an output to any appropriate location based on the nature of the process.

In the example of FIG. 1, the pressure sensor 102 is configured with a reference pressure 118, to which an input pressure of a fluid received via the fluid input line 106 is compared to output a pressure signal. For example, as discussed in more detail below, the pressure sensor 102 may be provided with a scalable evacuation port which may be sealed when the desired pressure is provided within the pressure sensor 102, and/or the pressure sensor 102 may be assembled and sealed within a volume having the desired reference pressure. The reference pressure 118 may be a vacuum pressure or another predetermined fixed reference pressure which may be below, at, or above a nominal atmospheric pressure. In some other examples, the reference pressure 118 may be configured as a variable pressure based on a fluid connection to another pressure source. In the configuration of FIG. 1, the pressure sensor 102 may be used as an absolute pressure sensor and/or a differential pressure sensor.

The example system 100 further includes an inlet filter 120. The inlet filter 120 is positioned between the process chamber 104 and the pressure sensor 102 to capture byproducts from the process chamber 104. The example inlet filter 120 may be integral with the fluid inlet line 106, attached to the fluid inlet line 106, integral to the pressure sensor 102, and/or attachable to the pressure sensor 102.

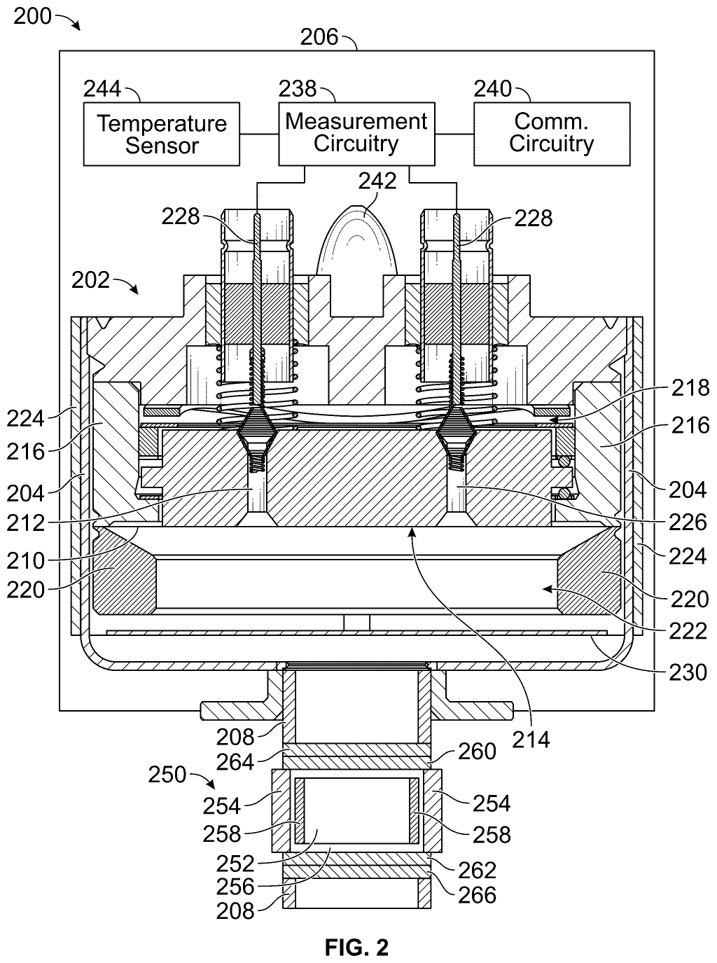

FIG. 2 is a schematic diagram of an example pressure sensor 200 including an inlet filter 250, which may be used to implement the pressure sensor 102 and the inlet filter 120 of FIG. 1. The example pressure sensor 200 includes a pressure measurement assembly 202, an inner housing 204, and an outer housing 206. The pressure sensor 200 receives a fluid via a fluid input line 208 (e.g., the fluid input line 106 of FIG. 1), measures the absolute pressure of the received fluid, and outputs one or more signals representative of the measured pressure.

The pressure measurement assembly 202 is a capacitive diaphragm gauge (CDG) sensor attached to the fluid input line 208. The pressure measurement assembly 202 may also be referred to as the “sensor core,” in that the pressure measurement assembly 202 performs the measurements which are converted to output signals. The pressure measurement assembly 202 is at least partially surrounded by the inner housing 204. The inner housing 204 may provide thermal insulation and/or physical protection to the pressure measurement assembly 202. Both the pressure measurement assembly 202 and the inner housing 204 are at least partially surrounded by the outer housing 206. The outer housing 206 may provide thermal insulation and/or physical protection to the pressure measurement assembly 202.

In the illustrated example, the pressure measurement assembly 202 is a capacitance pressure sensor, in which a flexible diaphragm 210 is separated from an electrode 212 by a gap 214. The pressure measurement assembly 202 includes a first body 216 that defines a reference pressure cavity 218, and a second body 220 that defines a measured pressure cavity 222. The second body 220 is coupled to the fluid input line 208, such that the measured pressure cavity 222 has the same pressure as the fluid in the fluid input line 208. For example, the second body 220 may be welded, brazed, or otherwise sealed against the fluid input line 208 to provide a hermetic seal.

As the pressure at the fluid input line 208 changes relative to a reference pressure in the reference pressure cavity 218 (e.g., a vacuum pressure), the diaphragm 210 moves or flexes, changing the capacitance at the measurement electrode 212 in an amount that corresponds to the pressure at the fluid input line 208 and/or in the measured pressure cavity 222.

In the example of FIG. 2, the pressure measurement assembly 202 further includes a reference electrode 226, which also measures the capacitance as the diaphragm 210 moves in response to the pressure. The electrodes 212, 226 are metalized to form two capacitances with the flexible diaphragm 210. The signals generated by both electrodes 212, 226 change with the pressure but change at different rates. The signals from the reference electrode 226 are output via signal ports 228, and may be used to measure and offset common mode error (e.g., temperature induced error).

The capacitance signal is output from the pressure measurement assembly 202 via the signal ports 228, which is coupled to measurement circuitry 238 that converts the capacitance to a measurement signal and/or outputs the capacitance signal to an external signal conversion device. The measurement circuitry 238 may correct the measurement signal(s). The measurement signal(s), representative of the measured pressure in the pressure measurement assembly 202, may then be transmitted by the measurement circuitry 238 (e.g., to the controller 116 of FIG. 1, to another control and/or data collection device, etc.) via communications circuitry 240 (e.g., a connector). In the example of FIG. 2, the example measurement circuitry 238 and the communications circuitry 240 are mounted within the pressure sensor 200 on one or more circuit boards.

To perform measurements and processing, the measurement circuitry 238 may be implemented using at least one controller or processor that controls the operations of the pressure sensor 200. The measurement circuitry 238 receives and processes multiple inputs. The measurement circuitry 238 may include one or more microprocessors, such as one or more “general-purpose” microprocessors, one or more special-purpose microprocessors and/or ASICS, and/or any other type of processing device. For example, the measurement circuitry 238 may include one or more digital signal processors (DSPs). The measurement circuitry 238 may further include memory devices and/or data storage devices.

The pressure sensor 200 may include a plasma shield 230 positioned between the fluid input line 208 and the diaphragm 210 to block contaminants, thereby reducing accumulation of contaminants on the diaphragm 210.

Example materials that may be used to construct the first body 216 and/or the second body 220 include corrosion resistant alloys, such as nickel alloys (e.g., Inconel® alloy) and/or superalloys, cobalt superalloys, iron superalloys, aluminum, copper alloys, titanium, and/or stainless steel.

To set a fixed reference pressure, the first body 216 may include an evacuation port 242 (e.g., a pinch tube or pinch-off tube). The evacuation port 242 is in fluid communication with the reference pressure cavity 218. During manufacturing and after scaling of the pressure measurement assembly 202, the pressure (e.g., vacuum or other set pressure) within the reference pressure cavity 218 is drawn via the evacuation port 242, which is pinched to seal the reference pressure cavity 218 when the desired pressure level is reached. In some other examples, the pressure measurement assembly 202 may be constructed and sealed in a volume in which the desired reference pressure is present, which fixes the desired reference pressure within the reference pressure cavity 218 when the evacuation port 242 is sealed via welding or pinch-off cold welding in a fixed pressure chamber.

In some examples in which a fixed reference pressure is set, a getter may be installed within the reference pressure cavity 218 and activated during manufacture, such as when the fixed reference pressure is established but before the reference pressure cavity 218 is sealed. Additionally or alternatively, the inner surfaces of the reference pressure cavity 218 (e.g., the first body 216 adjacent the reference pressure cavity 218, the electrode 212) are coated with a substance that reduces or prevents outgassing. An example coating that may be used is Parylene-C.

In some other examples, the evacuation port 242 may be left open to ambient pressure and/or connected to a variable source of reference pressure.

The inner housing 204 is attached to the second body 220 (e.g., using glue, welding, pressure fit, etc.). The outer housing 206 is secured to the measurement circuitry 238 and/or to the inner housing 204 (e.g., via fasteners, adhesive, welding, etc.).

The pressure sensor 200 further includes a temperature sensor 244 coupled to the measurement circuitry 238. The temperature sensor 244 measures an ambient or other environmental temperature that may affect the measurements by the electrodes 212, 226. For example, changes in temperature may change the size of the gap 214 and/or the tension of the diaphragm 210.

The example pressure sensor 200 further includes a heater 224, which may be wrapped around the inner housing 204. The heater 224 may be controlled to maintain the pressure sensor 200 at a predetermined temperature, which may improve stability of measurements.

The example inlet filter 250 is coupled to the fluid input line 208 of the pressure sensor 200 to capture byproducts or other contaminants present in process gas being measured by the pressure sensor 200. The inlet filter 250 may be integrated into the fluid input line 208 of the pressure sensor 200 or attached to the pressure sensor 200 along the fluid input line 208. The example inlet filter 250 includes a thermally conductive filter 252 in fluid communication with the fluid input line 208, such that process gas and contaminants flowing toward the pressure sensor 200 flow through the inlet filter 250.

As described in more detail below, the example thermally conductive filter 252 includes multiple surfaces to increase the surface area for capture of contaminants. The surfaces are arranged to at least partially impede the flow path of the process gas toward the fluid input of the pressure sensor 200.

The example inlet filter 250 further includes a cooler 254 in thermal communication with the thermally conductive filter 252. The cooler 254 cools the thermally conductive filter 252. The cooler 254 may be implemented using a thermoelectric cooler (e.g., a Peltier cooler) and/or a liquid cooler. For example, a thermoelectric cooler may be formed around the thermally conductive filter 252, and/or a liquid cooler may have fluid lines wrapped around the thermally conductive filter 252.

In the example of FIG. 2, the inlet filter 250 further includes an adapter 256, which may serve as a housing and/or connection between the thermally conductive filter 252 and the fluid input line 208. For example, the adapter 256 may include connectors 260, 262 or other coupling features for joining to a corresponding connectors 264, 266 of the fluid input line 208. The adapter 256 further includes a slot or bore for insertion and removal of the thermally conductive filter 252.

The adapter 256 is thermally conductive to conduct heat from the thermally conductive filter 252 to the cooler 254. In some examples, the thermal communication between the adapter 256 and the cooler 254 and/or between the adapter 256 and the thermally conductive filter 252 is improved using thermally conductive filler 258. The thermally conductive filler 258 may be a thermally conductive putty, a thermal paste, or other thermally conductive semi-fluid substance or filler.

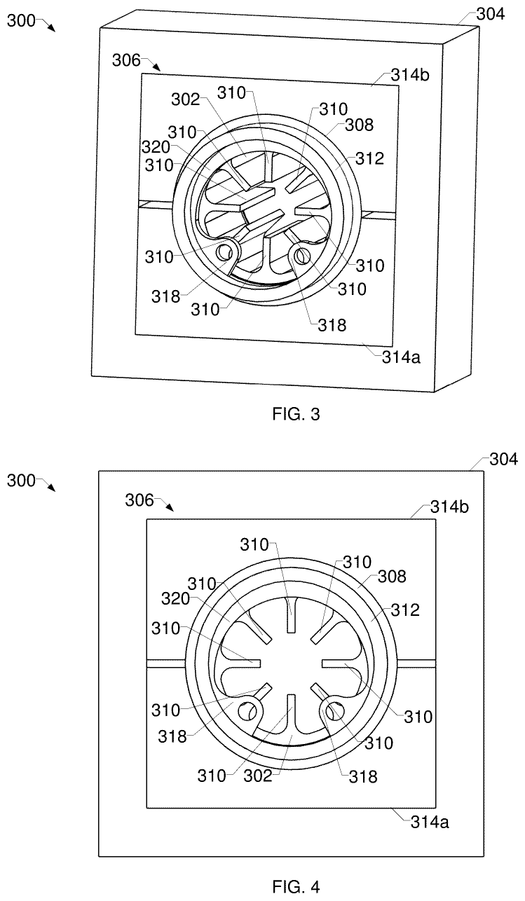

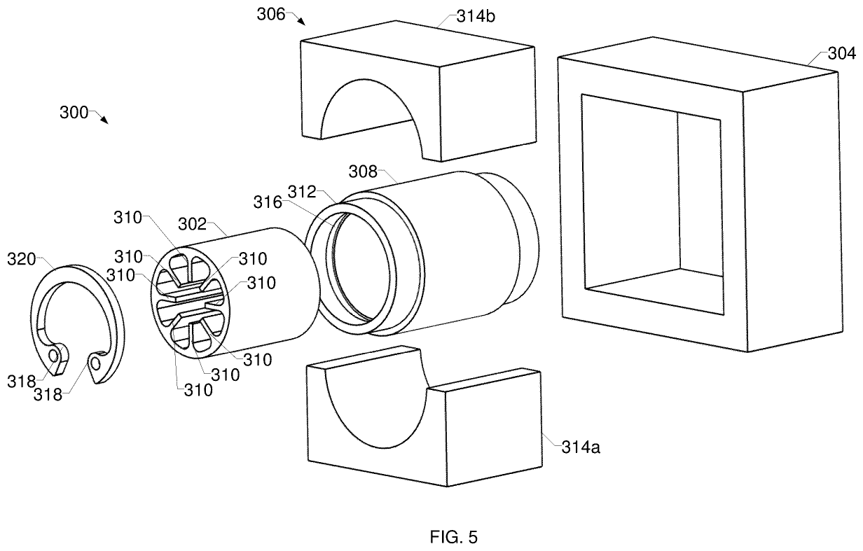

FIG. 3 is a perspective view of an example inlet filter 300 that may be used to implement the inlet filters 120, 250 of FIGS. 1 and 2. FIG. 4 is an end elevation view of the example inlet filter 300, and FIG. 5 is an exploded view of the inlet filter 300. The example inlet filter 300 includes a thermally conductive filter 302, a cooler 304, an adapter 306, and a thermally conductive filler 308.

The example thermally conductive filter 302 of FIGS. 3-5 is constructed of a thermally conductive, corrosion resistant material, such as stainless steel or a nickel alloy. The thermally conductive filter 302 is positioned in the flow path of process gas and contaminants to the pressure sensor 200. The filter 302 filters contaminants from the process gas prior to reaching the pressure sensor 200 by cooling the contaminants to less than a condensation temperature and collecting the condensed contaminants in the filter 302. To increase surface area for cooling and contaminant collection, the example filter 302 includes fins 310 which extend from an inner wall of the filter 302 into the flow path. The fins 310 improve contaminant collection without substantially increasing the response time of the sensor 200 to changes in process pressure.

The example filter 302 is insertable into, and removable from, the adapter 306. The example adapter 306 includes a tube 312 and an adapter housing 314. The tube 312 holds the filter 302 in place and in the flow path of the fluid input line 208. For example, the tube 312 may be configured to couple to one or more connectors used to connect the sensor 200 and/or the fluid input line 208 to the process chamber 104. Example connectors that may be used include a threaded connectors, quick-connect connectors, compression fittings, and/or any other type of connector that retains the pressure within the tube 312 and the fluid input line 208.

To provide thermal conduction between the filter 302 and the tube 312, the example filter 302 and the tube 312 may be configured to have a transition fit, such that the filter 302 can be inserted into the tube 312 with a small amount of force, but has a small clearance between the filter 302 and the tube 312. In other examples, the filter 302 may be inserted and removed with an interference fit having a low force (e.g., a force that be applied manually and/or with the use of tools).

The example thermally conductive filter 302 may be inserted into the tube 312 and retained using a retention ring 320 or other retention device. For example, the tube 312 includes a groove 316 around an inner circumference of the tube 312. The retention ring 320 has a resting outer circumference that is greater than the inner circumference of the tube 312. The retention ring 320 includes tabs 318, which may be squeezed together (e.g., using pliers) to reduce the circumference of the retention ring 320 sufficiently (e.g., reduce to less than the inner circumference of the tube 312) to allow insertion of the retention ring 320 into the tube 312. The retention ring 320 may then be allowed to expand into the groove 316 to retain the thermally conductive filter 302 within the tube 312. Similarly, the tabs 318 of the retention ring may be squeezed together to allow removal of the retention ring 320 and the filter 302 from the tube 312.

The example adapter housing 314 physically couples the tube 312 to the cooler 304. For example, the cooler 304 may have a different form factor and/or mechanical coupling system than the tube 312, which is configured to be coupled to the fluid input line 208. The example adapter housing 314 includes multiple pieces 314a, 314b. In the example of FIGS. 3-5, the thermally conductive filler 308 is placed between the adapter housing 314 and the tube 312.

In operation, the filter 302 is cooled by the cooler 304 (e.g., via the adapter housing 314, the thermally conductive filler 308, and the tube 312). As process gas and contaminants flow toward the sensor 200 through the fluid input line 208, the filter 302 cools the contaminants to less than a condensation temperature of the contaminants, causing the contaminants to condense onto the fins 310 of the filter 302. After a predetermined time period, during scheduled maintenance, or in response to a predetermined event (e.g., a reduction in response time by the sensor 200), the filter 302 may be removed from the tube 312 by removing the retention ring 320. The filter 302 may be cleaned or replaced with a new filter, and the retention ring 320 is reinstalled to retain the filter 302 in place.

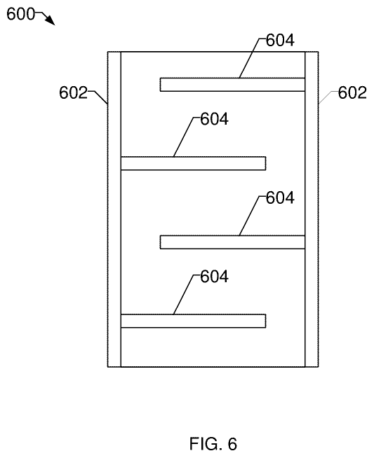

While an example thermally conductive filter 302 is illustrated in FIGS. 3-5, in other examples the filter 302, the cooler 304, the adapter 306, and/or the thermally conductive filler 308 may be modified for different applications. For example, the filter 302 may be modified to have different surfaces, flow paths, and/or other features. FIG. 6 is a cross-sectional view of another example thermally conductive filter 600 that may implement the thermally conductive filter 252 of FIG. 2. In the example of FIG. 6, the filter 600 has walls 602 and a set of fins 604. The walls 602 may be shaped to couple to the adapter 256 and/or the fluid input line 208, such that the filter 600 is within the flow path of the process gas to the sensor 200. In the example of FIG. 6, the fins 604 extend from the walls 602 to partially obstruct the flow path and to form a tortuous path for the process gas and contaminants to reach the sensor 200. The tortuous path increases the cooling of the contaminants, such that less power may be required to operate the cooler 254.

Returning to FIGS. 3-5, in other examples, the cooler 304 may be directly coupled to the filter 302, omitting the adapter 306 and/or the thermally conductive filler 308. For example, the cooler 304 may include or have a formed bore to receive the filter 302. Additionally or alternatively, the filter 302 may include connectors to directly couple the filter 302 to the fluid input line 208, and the cooler 304 is coupled directly to the filter 302 upon installation of the filter 302. In such examples, the filter 302 may be cleaned, or replaced with the included connector and a new filter and connector can be installed. The cooler 304 may then be reinstalled on the filter 302 following installation.

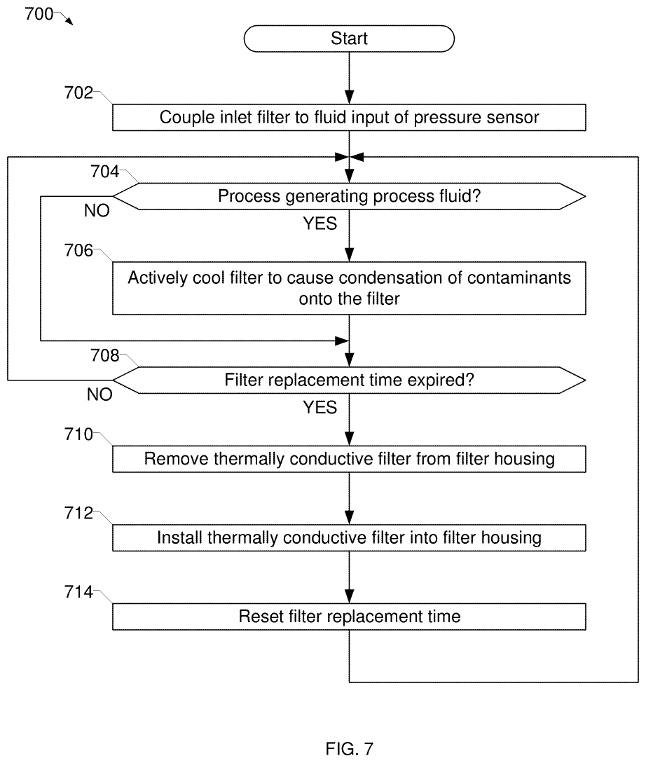

FIG. 7 is a flowchart representative of an example method 700 that may be performed to filter contaminants from an input to a pressure sensor, such as the pressure sensors 102, 200 of FIGS. 1 and 2. The example method 700 is described with reference to the example pressure sensor 200 and the example inlet filter 250 of FIG. 2.

At block 702, an inlet filter (e.g., the inlet filter 250) is coupled to a fluid input of a pressure sensor (e.g., the fluid input line 208 of the pressure sensor 200). For example, connectors 260, 262 attached to the adapter 256 of the inlet filter 250 may be connected to corresponding connectors 264, 266 of the fluid input line 208 between the process chamber 104 and the pressure sensor 200. In some other examples, the inlet filter 250 is integral to an integral fluid input line 208 of the pressure sensor 200.

At block 704, it is determined whether a process in the process chamber 104 is generating process fluid. For example, the communications circuitry 240 may receive requests for sensed pressure values and/or commands to perform pressure measurements via the pressure sensor 200. The communications circuitry 240 may be coupled to control circuitry for the cooler 254, or the cooler 254 may be powered by another control device communicatively linked to the control of the process chamber 104.

If the process is generating process fluid (block 704), at block 706 the filter 252 is actively cooled by the cooler 254 to cause condensation of contaminants onto the filter 252. For example, the cooler 254 may be powered during processing or operation of the process chamber 104 to remove contaminants from the process fluids to be sensed by the pressure sensor 200.

While actively cooling the filter (block 706), or if the process is not generating process fluid (block 706), at block 708 it is determined whether a filter replacement time has expired. For example, the filter 252 may be schedule for replacement at predetermined intervals. The intervals may be an absolute intervals (e.g., scheduled maintenance periods) and/or process-based intervals (e.g., a number of hours of operating the process chamber 104). If the filter replacement time has not expired (block 708), control returns to block 704.

When the filter replacement time has expired (block 708), at block 710 the thermally conductive filter 252 is removed from a filter housing, such as the tube 312 of FIGS. 3-5, from the adapter 256 of FIG. 2, or another type of housing. For example, a retaining device (e.g., the retention ring 320 of FIGS. 3-5) holding the filter 252 in place may be removed to permit removal of the filter 252 from the adapter 256.

At block 712, a thermally conductive filter 252 is installed into the housing. The installed filter 252 may be a cleaned, previously used filter or a new replacement filter. The filter 252 may be installed in a reverse order of block 710, such as by inserting the filter and installing a retaining device.

At block 714, the filter replacement time is reset. Control then returns to block 704 to continue filtering during processing.

As utilized herein, “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made, and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

1. A pressure sensor, comprising:
a pressure sensor comprising a fluid input and a sensor housing configured to contain a reference pressure, and configured to output a signal representative of a pressure sensed at the fluid input; and
an inlet filter configured to reduce byproducts entering the pressure sensor with a process gas, the inlet filter comprising:
a thermally conductive filter in fluid communication with the fluid input of the pressure sensor, and comprising a plurality of surfaces at least partially impeding a flow path of the process gas toward the fluid input of the pressure sensor; and
a cooler thermally coupled to the thermally conductive filter and configured to cool the thermally conductive filter.

2. The pressure sensor as defined in claim 1, wherein the thermally conductive filter comprises a plurality of fins extending from an inner wall of the thermally conductive filter into the flow path.

3. The pressure sensor as defined in claim 1, wherein the thermally conductive filter comprises at least one of stainless steel or a nickel alloy.

4. The pressure sensor as defined in claim 1, wherein the cooler comprises at least one of a thermoelectric cooler or a liquid cooler.

5. The pressure sensor as defined in claim 1, wherein the inlet filter further comprises a filter housing coupled to the fluid input and configured to hold the thermally conductive filter in the flow path.

6. The pressure sensor as defined in claim 5, wherein the filter housing is coupled to the fluid input via a connector.

7. The pressure sensor as defined in claim 5, wherein the filter housing is integrated into the fluid input.

8. The pressure sensor as defined in claim 5, further comprising a retaining ring configured to be removably installed in the filter housing to retain the thermally conductive filter in a predetermined position.

9. The pressure sensor as defined in claim 8, wherein the thermally conductive filter is removable from the filter housing when the retaining ring is removed.

10. The pressure sensor as defined in claim 1, further comprising at least one of an adapter or a thermally conductive filler, the at least one of the adapter or the thermally conductive filler configured to transfer heat from the thermally conductive filter to the cooler.

11. An inlet filter for a pressure sensor, the inlet filter comprising:
a thermally conductive filter configured to be installed in fluid communication with a fluid input of a pressure sensor, and comprising a plurality of surfaces configured to at least partially impede a flow path through the thermally conductive filter; and
a cooler thermally coupled to the thermally conductive filter and configured to cool the thermally conductive filter.

12. The inlet filter as defined in claim 11, wherein the thermally conductive filter comprises a plurality of fins extending from an inner wall of the thermally conductive filter into the flow path.

13. The inlet filter as defined in claim 11, wherein the cooler comprises at least one of a thermoelectric cooler or a liquid cooler.

14. The inlet filter as defined in claim 11, further comprising a filter housing coupled to the fluid input and configured to hold the thermally conductive filter in the flow path.

15. The inlet filter as defined in claim 14, further comprising a retaining ring configured to be removably installed in the filter housing to retain the thermally conductive filter in a predetermined position.

16. The inlet filter as defined in claim 15, wherein the thermally conductive filter is removable from the filter housing when the retaining ring is removed.

17. The inlet filter as defined in claim 14, wherein the filter housing is configured to be coupled to the fluid input via a first connector.

18. The inlet filter as defined in claim 17, wherein the filter housing is configured to be coupled to a source of process gas via a second connector, the thermally conductive filter configured to be positioned between the first connector and the second connector.

19. The inlet filter as defined in claim 14, wherein the filter housing is integrated into the fluid input.

20-21. (canceled)

22. A method to filter an input to a pressure sensor, the method comprising:
coupling an inlet filter to a fluid input of the pressure sensor, the inlet filter comprising a thermally conductive filter in fluid communication with the fluid input of the pressure sensor, and comprising a plurality of surfaces at least partially impeding a flow path toward the fluid input of the pressure sensor;
actively cooling the filter to cause condensation of contaminants onto the filter; and
at least one of cleaning the filter or replacing the filter to remove the contaminants from the flow path.
